(19) United States
(12) Patent Application Publication
(10) Pub. No.: US 2023/0205746 A1
(43) Pub. Date: Jun. 29, 2023

(54) DETERMINATION OF RECOMMENDED COLUMN TYPES FOR COLUMNS IN TABULAR DATA

(71) Applicant: Microsoft Technology Licensing, LLC, Redmond, WA (US)

(72) Inventors: Idan Yehoshua Hen, Tel Aviv (IL); Idan Belaiev, Tel Aviv (IL)

(73) Assignee: Microsoft Technology Licensing, LLC, Redmond, WA (US)

(21) Appl. No.: 17/561,377

(22) Filed: Dec. 23, 2021

(51) Int. Cl. G06F 16/22

(52) U.S. Cl. CPC G06F 16/221

(57) ABSTRACT

According to examples, an apparatus may include a processor and a memory on which are stored machine-readable instructions that, when executed by the processor, may cause the processor to receive tabular data of a data source and extract a characteristic of a column based on the received tabular data The processor may determine, through application of modeling, a recommended column type from a predefined table format based on the extracted characteristic of the column. The recommended column type may have at least a predetermined level of match to the extracted characteristic of the column. The processor may assign the recommended column type as a type of the column in the received tabular data to normalize the received tabular data to the predefined table format.

### BACKGROUND

Data from data sources may be maintained in tables in a predetermined format. In many instances, the format of the data, such as names of columns of tables, may vary based on the data sources.

### BRIEF DESCRIPTION OF THE DRAWINGS

Features of the present disclosure are illustrated by way of example and not limited in the following figure(s), in which like numerals indicate like elements, in which:

FIG, 1 depicts a block diagram of an apparatus that may extract a characteristic of a column based on tabular data of a data source and determine, through application of modeling, a recommended column type for the column from a predefined table format, in accordance with an embodiment of the present disclosure;

FIG. 2 shows a block diagram of a system within which the apparatus depicted in FIG. 1 may be implemented, in accordance with an embodiment of the present disclosure;

FIG, 3 shows a block diagram of example tables, which may be implemented in the system depicted in FIG. 2, including a table of a data source, a predefined table format, and a normalized table of the data source to the predefined table format, in accordance with an embodiment of the present disclosure;

FIG. 4A shows a diagram of an example characteristic of columns from different data sources, in which the example characteristic may be a column/field name having similar keywords, in accordance with an embodiment of the present disclosure;

FIG. 4B shows a diagram of an example characteristic of columns from different data sources, in which the example characteristic may be a cardinality of values of data in the column, in accordance with an embodiment of the present disclosure;

FIG. 4C shows a diagram of an example characteristic of columns from different data sources, in which the example characteristic may be based on a regular expression (regex), in accordance with an embodiment of the present disclosure;

FIG. 5 shows a flow diagram of a method for determining a feature set fora model based on an extracted characteristic of a column, and determining, through application of the model, a recommended column type from a predefined table format, in accordance with an embodiment of the present disclosure; and

FIG. 6 depicts a block diagram of a computer-readable medium that may have stored thereon computer-readable instructions to extract a feature set of a column of a table, generate a feature vector for the column based on the extracted feature set, and determine a recommended column type from a predefined table format through application of modeling using the feature vector, in accordance with an embodiment of the present disclosure.

### DETAILED DESCRIPTION

For simplicity and illustrative purposes, the principles of the present disclosure are described by referring mainly to embodiments and examples thereof. In the following description, numerous specific details are set forth in order to provide an understanding of the embodiments and examples. It will be apparent, however, to one of ordinary skill in the art, that the embodiments and examples may be practiced without limitation to these specific details. In some instances, well known methods and/or structures have not been described in detail so as not to unnecessarily obscure the description of the embodiments and examples. Furthermore, the embodiments and examples may be used together in various combinations.

Throughout the present disclosure, the terms “a” and “an” are intended to denote at least one of a particular element. As used herein, the term “includes” means includes but not limited to, the term “including” means including but not limited to. The term “based on” means based at least in part on.

A computing device may receive and store data from a data source or from multiple data sources to provide services based on analysis of the received data. In some examples, the computing device may provide security services, for instance, next-generation security information and event management solutions (NG-SIEM), which may provide real-time analysis of security alerts generated by applications and network hardware of the data sources.

A concern associated with maintaining and analyzing data from data sources may be “understanding the data.” For instance, different data sources may include various types of data and in various types of formats, which may be different across each of the different data sources. In such instances, providing out-of-the-box (OOTB) functionality to provide services, such as NG-SIEM, based on the various data formats from different data sources may be difficult because of the various types of formats used by the different data sources.

By way of particular example to illustrate such issues, a computing device may receive data from a virtual private network (VPN) data source to provide advanced analytics to the VPN data source. In this example, the computing device may not be aware of a format of the received data because, for instance, each data source may have one of a number of data formats. For instance, a log received from a first data source may have a predefined data format, such as a predefined set of columns and/or fields, which may be different than that of a second data source. In this example, the first data source and the second data source may both have a column for user names, but the first data source may have a predefined data format in which the user name column is called “username,” whereas the second data source may call the column “user.name.” In these instances, if the computing device is not aware of the data format for the particular data source, the computing device may not be able to provide all of the services that it may be able to provide. As such, it may be difficult to scale support for a large number of different data sources, which may have different data formats.

To address such issues, the computing device may normalize the data from the different data sources to a predefined format that can be understood by the computing device. However, normalization may be a difficult process because, in many cases, an administrator may need to perform the normalization process manually. For instance, a user at a particular data source that wishes to gain all of the OOTB value provided by an NG-SIEM solution at the computing device may parse different fields in their data based on a normalized schema of the computing device. As used herein, a normalized schema may refer to a predefined format for the data that the service on the computing device expects, such as a predefined format for table columns and fields, and/or the like. In some examples, the data from different data sources may be normalized by parsing the data, for instance, by rearranging or reformatting the data to be in the same format as the normalized schema.

However, in these instances, it may be inefficient to normalize the incoming data, particularly in cases where an administrator may need to manually identify the incoming data. A technical issue with normalizing incoming data may be that conventional techniques for normalizing the incoming data may be time and/or computing resource intensive in instances in which the incoming data includes a large volume of data for which the format may be different and/or unknown.

Disclosed herein are apparatuses, systems, methods, and computer-readable media that may enable efficient normalization of data from a data source to a predefined format of a normalized schema. As discussed herein, a processor may receive tabular data of a data source and extract a characteristic of a column based on the received tabular data, Based on the extracted characteristic of the column, the processor may determine, through application of modeling, a recommended column type from a predefined table format of the normalized schema. In some examples, the processor may output multiple recommended column types for a particular column in order to enable a user to more quickly and easily decide how to normalize the tabular data. The recommended column type may have at least a predetermined level of match to the extracted characteristic of the column. The processor may assign the recommended column type as a type of the column of the received tabular data to normalize the received tabular data to the predefined table format.

Through implementation of the features of the present disclosure, a processor may enable improved normalization of data from data sources, which may reduce latency and consumption of processing resources by leveraging machine learning models to automate the normalization process rather than performing manual normalization, which in turn may improve efficiency in on-boarding new data sources. A technical improvement afforded through implementation of the features of the present disclosure may be that the speed and accuracy in which managed services, such as security information and event management (SIEM) services may be provided, may be improved, which may also reduce energy and resource consumption in the normalization of the data to the predefined table format.

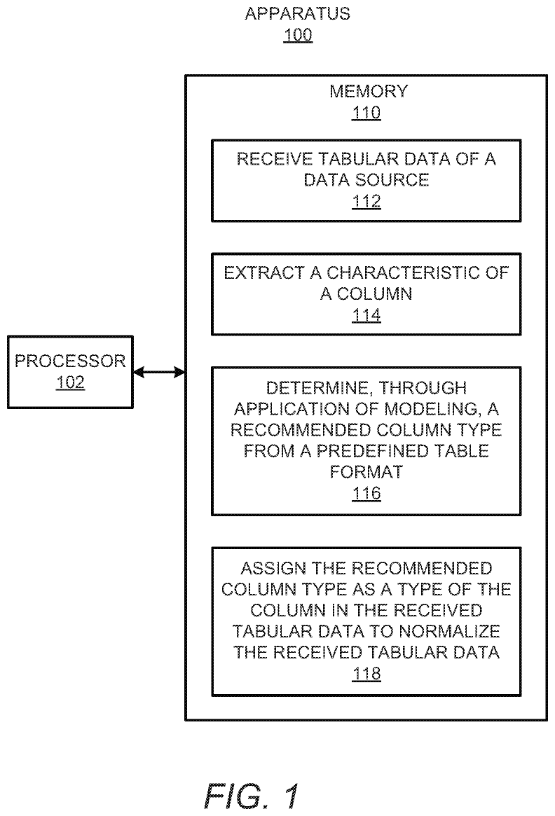

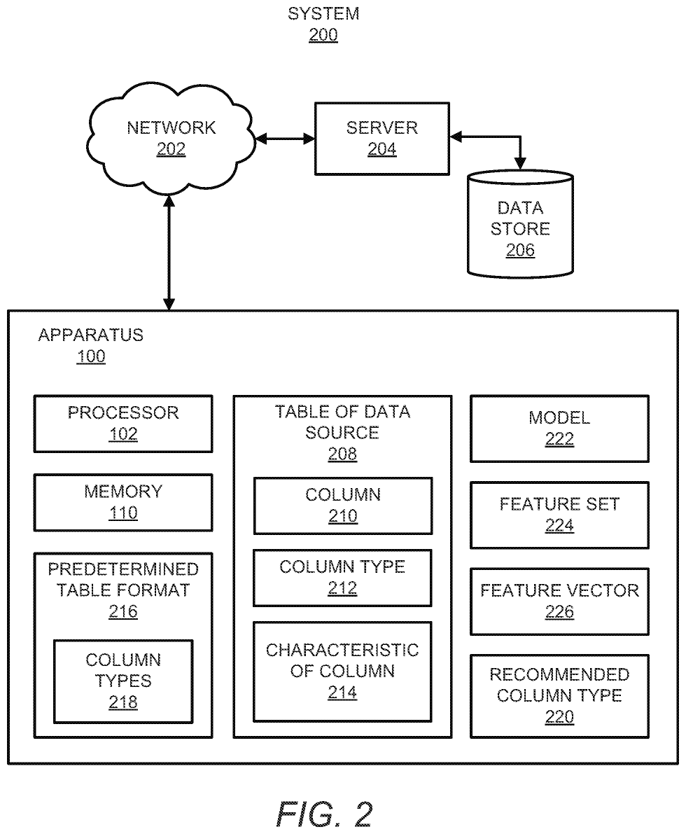

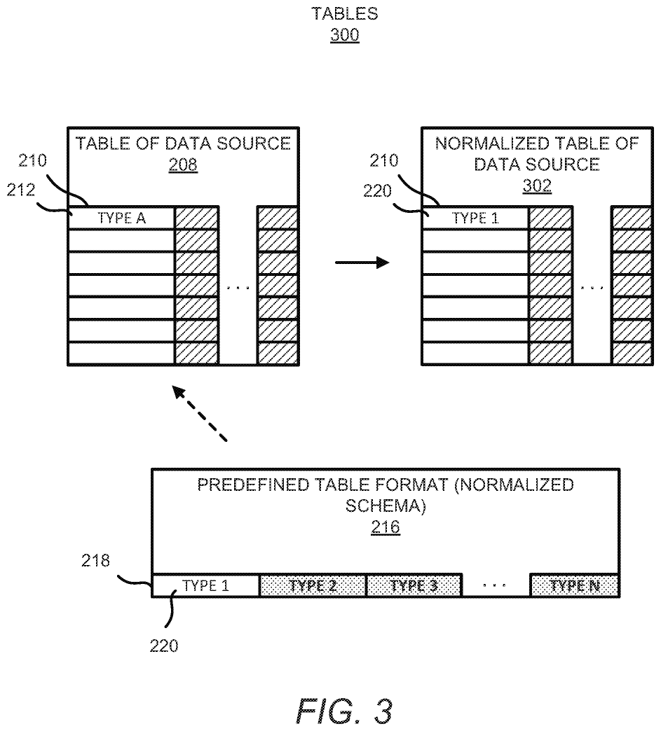

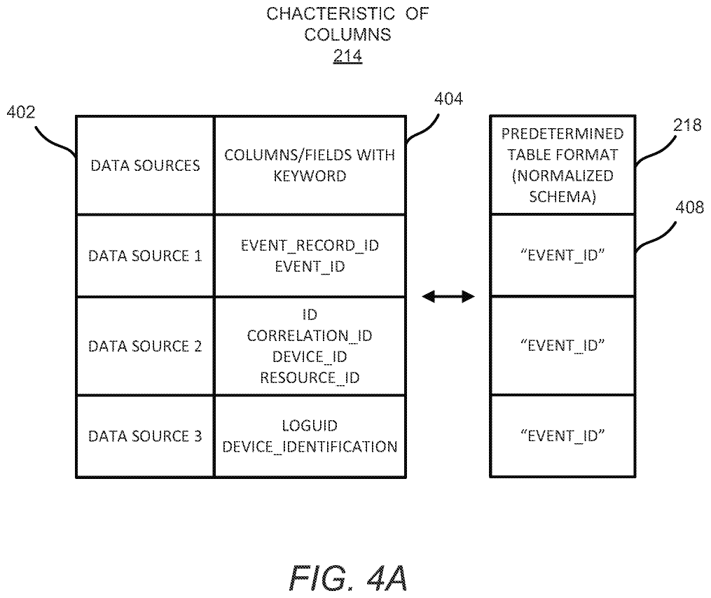

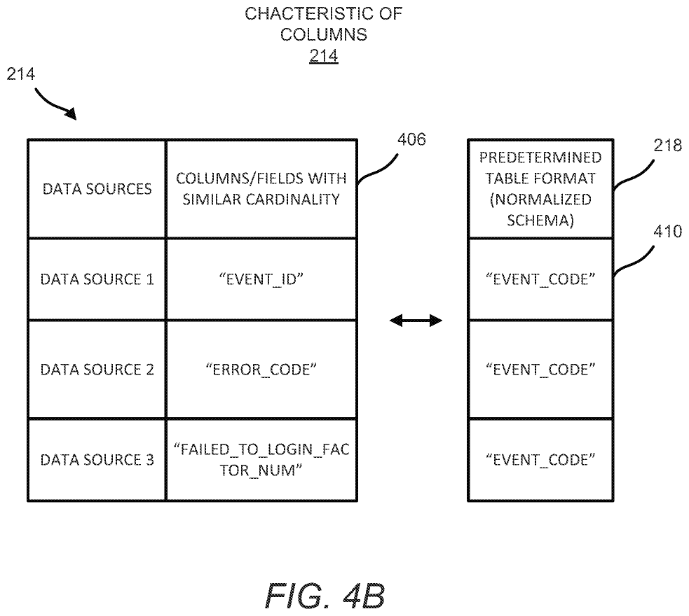

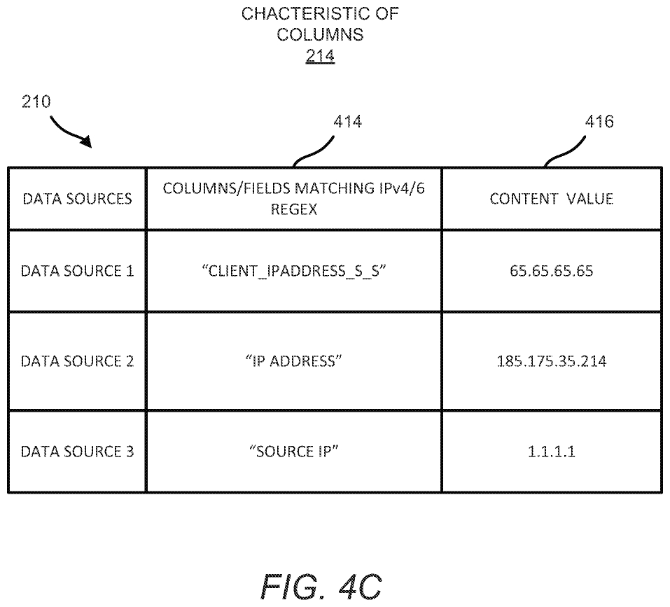

Reference is made to FIGS. 1, 2, 3, and 4A to 4C. FIG. 1 shows a block diagram of an apparatus 100 that may extract a characteristic of a column based on tabular data of a data source and determine, through application of modeling, a recommended column type for the column from a predefined table format, in accordance with an embodiment of the present disclosure. FIG. 2 shows a block diagram of an example system 200 that may include the apparatus 100 depicted in FIG. 1, in accordance with an embodiment of the present disclosure. FIG. 3 shows a block diagram of example tables 300, which may be implemented in the system depicted in FIG. 2, including a table 208 of a data source, a predefined table format 216, and a normalized table 302 of the data source to the predefined table format 216, in accordance with an embodiment of the present disclosure. FIG. 4A shows a diagram of an example characteristic 214 of columns from different data sources, in which the example characteristic 214 may be a column/field name having similar keywords, in accordance with an embodiment of the present disclosure. FIG. 4B shows a diagram of an example characteristic 214 of columns from different data sources, in which the example characteristic 214 may be a cardinality of values of data in the column, in accordance with an embodiment of the present disclosure. FIG. 40 shows a diagram of an example characteristic 214 of columns from different data sources, in which the example characteristic 214 may be based on a regular expression (regex), in accordance with an embodiment of the present disclosure. It should be understood that the apparatus 100 depicted in FIG. 1, the system 200 depicted in FIG. 2, the tables 300, and/or the characteristics 214 depicted in FIG. 4 may include additional features and that some of the features described herein may be removed and/or modified without departing from the scopes of the apparatus 100, the system 200, the tables 300, and/or the characteristics 214.

The apparatus 100 may include a processor 102 and a memory 110. The apparatus 100 may be a computing device, including a server, a node in a network (such as a data center or a cloud computing resource), a desktop computer, a laptop computer, a tablet computer, a smartphone, an electronic device such as Internet of Things (IoT) device, and/or the like. The processor 102 may include a semiconductor-based microprocessor, a central processing unit (CPU), an application-specific integrated circuit (ASIC), a field-programmable gate array (FPGA), and/or other hardware device. In some examples, the apparatus 100 may include multiple processors and/or cores without departing from a scope of the apparatus. In this regard, references to a single processor as well as to a single memory may be understood to additionally or alternatively pertain to multiple processors and multiple memories.

The memory 110 may be an electronic, magnetic, optical, or other physical storage device that contains or stores executable instructions. The memory 110 may be, for example, Read Only Memory (ROM), flash memory, solid state drive, Random Access memory (RAM), an Electrically Erasable Programmable Read-Only Memory (EEPROM), a storage device, an optical disc, or the like. The memory 110 may be a non-transitory computer-readable medium. The term “non-transitory” does not encompass transitory propagating signals.

As shown in FIG. 1, the processor 102 may execute instructions 112-118 to normalize data from a data source. The instructions 112-118 may be machine-readable instructions, e.g., non-transitory computer-readable instructions. In other examples, the apparatus 100 may include hardware logic blocks or a combination of instructions and hardware logic blocks to implement or execute functions corresponding to the instructions 112-118,

The apparatus 100 may be connected via a network 202, which may be the Internet, a local area network, and/or the like, to a server 204. In addition, a data store 206 may be connected to the server 204. In some examples, the server 204 may maintain a data source, such as the data sources 402 depicted in FIG. 4. The data sources 402 may be cloud-based data warehouses, data centers, and/or the like, which may be maintained by the server 204 or multiple servers 204.

The processor 102 may fetch, decode, and execute the instructions 112 to receive a table 208 of a data source. As used herein, the table 208 may be the same as “tabular data” that may form the table 208, and these terms may be used interchangeably. As used herein, tabular data may include content of columns/fields of tables as well as information about the columns/fields, such as information stored in metadata for the columns/fields. In some examples, the table 208 may be a log maintained at the data source. In some examples, the table 208 may include security and event information.

The processor 102 may fetch, decode, and execute the instructions 114 to extract a characteristic 214 of the column 210 in the received table 208 (or tabular data). In some examples, the column 210 in the table 208 may be arranged in a certain format, which may vary based on the data source. For instance, the column 210 may have an assigned column type 212, and in this case, the data in the table 208 may be arranged based on the column type 212. By way of particular examples, the column type 212 may include a name of the column, a data type of the column, and/or the like, such as a date of an operation, a type of an operation, an outcome of an operation, a user name, a user type, a device name, a domain, an address, and/or the like. In this regard, the format of the table 208, including the column type 212, may be unknown to the processor 102 when the table 208 is received and/or may be different than column types 218 of a predefined table format 216.

The column 210 may also include the characteristic 214 of the column 210. The characteristic 214 of the column 210 may include various types of properties of the column 210. In some instances, the characteristic 214 may be based on the column type 212. By way of particular examples and for purposes of illustration, the characteristic 214 may include properties of the column 210 such as a name of the column 210, a type of data in the column 210 such as numbers or text, a cardinality of distinct values of a field of the column 210, a property based on a regex such as how well a content of the column 210 fits a search pattern, a column data type, and/or the like. In some examples, the characteristic 214 may be extracted from metadata for the table 208.

The processor 102 may fetch, decode, and execute the instructions 116 to, based on the extracted characteristic 214, determine, through application of modeling, a recommended column type 220 from a predefined table format 216. As depicted in FIG. 3, the column 210 may be one among a plurality of columns included in the received table 208. The column 210 may be assigned a column type 212, for instance “TYPE A.” The processor 102 may apply the model 222 to identify potential column types among the column types 218 of the predefined table format 216 that are likely to match the column type 212. In this regard, the processor 102 may apply the model 222 using the extracted characteristic 214 of the column 210 to determine the recommended column type 220 among the column types 218 of the predefined table format 216. The recommended column type 220 may be one among the column types 218 of the predefined table format 216 having a predetermined level of match to the extracted characteristic 214 of the column 210. The predefined table format 216 may be a user-defined table format, a format of tables currently being employed in a database, a format that may enable efficient analysis by an application of the data stored in the tables, and/or the like.

By way of particular example and as depicted in FIG. 3, the processor 102 may determine, through application of the model 222, that the column type 212, which has a value “TYPE A,” matches most closely to the recommended column type 220, which has a value “TYPE 1,” based on the extracted characteristics 214. The processor 102 may rank the similarities between the column type 212 of the column 210 and each of the column types 218 of the predefined table format 216. In this example, the processor 102 may determine that the recommended column type 220 has at least the predetermined level of match to the extracted characteristic 214 of the column 210, and as such may identify the column type “TYPE 1” as the recommended column type 220. In these instances, the processor 102 may determine that the remaining column types 218, for instance column types “TYPE 2” to “TYPE N,” may be below the predetermined level of match to the extracted characteristic 214 of the column 210, and as such may not identify the remaining column types 218 as potential matches for the column 210.

In some examples, the model 222 may be trained using a sample log from a data source. For instance, the received table 208 of the data source may be a sample log from the data source that includes a subset of the data from the data source, including the column 210, column type 212, and characteristics 214 of the column 210. The processor 102 may extract the characteristic 214 of the column 210, for instance, through metadata for the column 210 in the table 208, and may use the extracted characteristic 214 to train the model 222. The model 222 may be trained using any suitable machine learning technique, such as linear regression, logistic regression, decision tree, naive Bayes, kNN, and/or the like.

In some examples, the processor 102 may create a feature set 224 based on the extracted characteristic 214 to train the model 222. The feature set 224 may include the features correlated to the extracted characteristic 214 of the column 210. In some examples, the features of the feature set 224 of the column 210 may include a field type, a data type, a value of content in the column 210, a number of distinct values of data in the column 210, a regular expression (regex) of content in the column 210, and/or the like.

The processor 102 may generate a feature vector 226 for the column 210 based on the feature set 224. In some examples, the feature vector 226 may represent characteristics of the column 210 based on the features of the feature set 224. The feature vector 226 may be unique to the column 210. In some examples, the processor 102 may generate a unique feature vector 226 for each of the columns in the table 208 of the data source.

The characteristic 214 of the column 210, which may be a feature of the feature set 224, may include various types of characteristics. For instance, the features in the feature set 224 may include column names correlated to the column, cardinality of values of data in the column, patterns of characters in the column, column data type correlated to the column, column content correlated to the column, and/or the like. By way of particular examples and for purposes of illustration, FIGS. 4A, 4B, and 40 depict example characteristics of columns including column/field names, number of distinct values or cardinality of values, and features based regex, respectively.

Referring first to FIG. 4A, the characteristic 214 may be a name of a column or field, and in this example, the processor 102 may train the model 222 based on a similarity score based on column names 404. For instance, a column in the predefined table format 216 may include a column named “EVENT_ID,” which may include a keyword “ID.” In this example, the table 208 received from Data Source 1 may include two columns/fields that includes the keyword “ID”: “EVENT_RECORD_ID” and “EVENT_ID.” Although a name that includes the keyword “ID” may represent something different than the “EVENT_ID” 408 in the predefined table format 216, the columns in the tables of the data sources 402 that include this keyword “ID” may be suggested with a relatively high confidence as being a relevant to the column “EVENT_ID” 408 in the predefined table format 216. In this example, the processor 102 may identify both columns/fields that include the keyword “ID”.

Referring to FIG. 4B, the characteristic 214 may be a number of distinct values or cardinality of values 406. Cardinality may be a number of distinct values that may be possible for a particular column or field. For instance, certain fields may have a limited number of possible values and thus a relatively smaller cardinality, while other fields may have a different unique value for each event and thus a relatively larger cardinality. The processor 102 may determine the recommended column type 220 based on the cardinality of the column 210.

In some examples, multiple characteristics 214 or features may be applied to determine the recommended column type 220. Continuing with the previous example in which the Data Source 1 includes two columns that include the keyword “ID,” the processor 102 may apply the characteristic 214, for instance, based on the cardinality of values to further narrow the match to a column type 218 in the predefined table format 216. For instance, “EVENT_ID” in the received column 210 may have a limited number of possible values, while “EVENT_RECORD_ID” may have a different value for each event. In this case, based on the cardinality of value for “EVENT_ID”, the processor 102 may determine that “EVENT ID” in the received column 210 has a relatively higher level of match with “EVENT_CODE” 410 in the predefined table format 216, rather than “EVENT_ID” 408, for example.

Referring to FIG. 4C, the characteristic 214 may be based on regex, or regular expression. Regex may be a sequence of characters that may specify a search pattern. Such patterns may be used in search operations, for input validations, and/or the like. The tables from the data sources 402 may include a name 414 of the column/field and a content value 416, which may match a specific format. In some examples, different data sources 402 may have different names 414 for the same type of data. By way of particular example, an IP field may include a value 416 in a specific format, such as in IPv4 or IPv6 format. In this example, Data Source 1 may name this field ‘CLIENT_IPADDRESS_S_S’ and may have a content value 416 of “65.65.65.65,” Data Source 2 may name this field “IP ADDRESS” and may have a content value 416 “185.175.35.214,” and Data Source 3 may name this field “SOURCE IP” and may have a content value 416 “1.1.1.1.” While the name 414 of the column/field for each of the data sources 402 may be different, the format of the content value 416 may correlate to a specific format, such as the IPv4 or IPv6 format. The processor 102 may use the format of the content value 416 based on regex to determine whether the field having the names 414 and content value 416 matches an IP field. In some examples, the processor 102 may further define the feature set 224 and the feature vector 226, for instance, to differentiate between a source IP address, a destination IP address, a client IP address, a server IP address, and/or the like.

In some examples, based on the extracted characteristic 214 of the column 210, the processor 102 may determine a ranking of column types 218 of the predefined table format 216 based on a respective level of match to the extracted characteristic 214 of the column 210. The processor 102 may select, as the recommended column type 220, one or more than one column types 218 of the predefined table format 216 having at least the predetermined level of match to the extracted characteristic 214 of the column 210. In some examples, the processor 102 may apply multiple features or characteristics 214 to rank the column types 218 for a match against the column 210.

In some examples, the processor 102 may output the recommended column type 220. In some examples, the processor 102 may output the recommended column type 220 for selection or confirmation by a user. For instance, the recommended column type 220 may be one among a plurality of recommended column types 220 that is output to the user. In some examples, the processor 102 may output the recommended column types 220 to a display device at the apparatus 100, at the server 204 for the data source, and/or the like. The recommended column type 220 that is output may be a predetermined number of top ranked column types 218 of the predefined table format 216 as determined via the model 222. In cases in which multiple recommended column types 220 are output to the user, the user may select one of output recommended column types 220 to confirm the recommended column type 220 that matches the column 210.

Based on a selection of one of the plurality of recommended column types 220, the processor 102 may update or retrain the model 222 to account for the selection, in order to improve the accuracy of the model 222. In this regard, the processor 102 may generate subsequent recommendations for column types based on the updated model 222.

The processor 102 may fetch, decode, and execute the instructions 118 to assign the recommended column type 220 as the column type 212 of the received table 208 to normalize the received table 208 to the predefined table format 216. In some examples, the processor 102 may replace the existing column type 212 with the recommended column type 220 in order to normalize the received table 208 according to the predefined table format 216. In some examples, the processor 102 may assign the recommended column type 220 to an appropriate column 210 in the table 208, without user intervention, to automate normalization of the table 208 to the predefined table format 216.

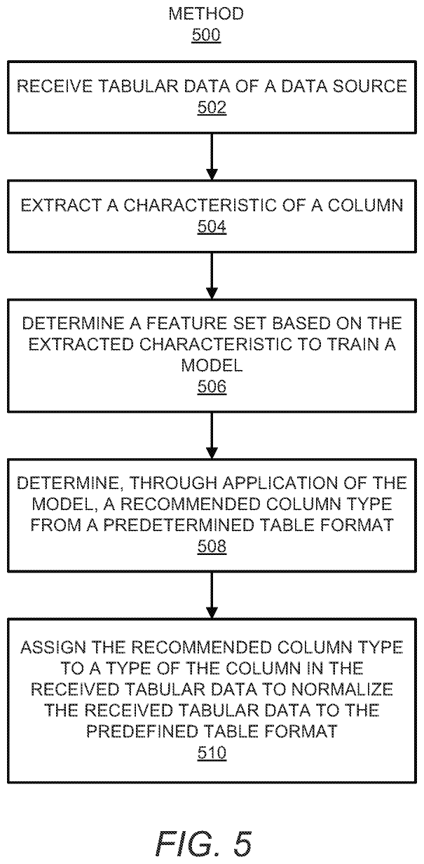

Various manners in which a processor implemented on the apparatus 100 may operate are discussed in greater detail with respect to the method 500 depicted in FIG. 5. FIG. 5 depicts a flow diagram of a method 500 for determining a feature set for a model based on extracted characteristic of a column, and determining through application of the model a recommended column type from a predefined table format, in accordance with an embodiment of the present disclosure. It should be understood that the method 500 depicted in FIG. 5 may include additional operations and that some of the operations described therein may be removed and/or modified without departing from the scope of the method 500. The description of the method 500 is made with reference to the features depicted in FIGS. 1, 2, 3, and 4A to 40 for purposes of illustration,

At block 502, the processor 102 may receive a table 208 of a data source. The table 208 may be tabular data for a plurality of columns and characteristics of the columns. In some examples, the characteristics of the columns may be stored in metadata.

At block 504, the processor 102 may extract a characteristic 214 of the column 210 based on the tabular data. In some examples, the extracted characteristic 214 may include a plurality of characteristics of the column 210. The extracted characteristic 214 may be a feature of a feature set 224 for a machine learning model, such as the model 222 in FIG. 2.

At block 506, the processor 102 may determine the feature set 224 based on the extracted characteristic 214 to train the model 222. The processor 102 may run the model 222 to match the extracted characteristic 214 of the column 210 to a column type 218 from a predefined table format 216.

At block 508, the processor 102 may determine, through application of the model 222, a recommended column type 220 from the predefined table format 216. The recommended column type 220 may have at least a predetermined level of match to the extracted characteristic 214 of the column 210. In some examples, the processor 102 may identify multiple recommended column types 220 among the column types 218 in the predefined table format 216 as a match for the column 210.

At block 510, the processor 102 may assign the recommended column type 220 to a type of the column of the received table, such as the column type 212 depicted in FIG. 2, to normalize the received table 208 to the predefined table format 216.

In some examples, features of the determined feature set 224 may include a field type, a data type, a value of content in the column, a number of distinct values of data in the column, a regular expression (regex) of content in the column, and/or the like.

The processor 102 may generate a feature vector 226 correlated to the column 210 based on the feature set 224. The feature vector 226 may represent the column 210 based on the features of the feature set 224. In some examples, the features in the feature set 224 may include column names correlated to the column 210, cardinality of values of data in the column 210, patterns of characters in the column 210, column data type correlated to the column 210, column content correlated to the column 210, and/or the like.

The processor 102 may determine a ranking of column types 218 of the predefined table format 216 based on a respective level of match to the extracted characteristic 214 of the column 210. The processor 102 may select, as the recommended column type 220, one or more than one column type 218 of the predefined table format 216 having at least the predetermined level of match to the extracted characteristic 214 of the column 210.

The processor 102 may output the recommended column type 220. In some examples, the recommended column type 220 may include a plurality of recommended column types 220. Based on a selection of one of the plurality of recommended column types 220, the processor 102 may assign the selected column type as the column type 212 to normalize the column 210 in the received table 208.

The processor 102 may update the model 222 based on the selected column type. In some examples, the processor 102 may retrain the model 222 based on the selected column type. The processor 102 may generate subsequent recommendations for column types based on the updated model 222.

Some or all of the operations set forth in the method 500 may be included as utilities, programs, or subprograms, in any desired computer accessible medium. In addition, the method 500 may be embodied by computer programs, which may exist in a variety of forms both active and inactive. For example, they may exist as machine-readable instructions, including source code, object code, executable code or other formats. Any of the above may be embodied on a non-transitory computer-readable storage medium.

Examples of non-transitory computer-readable storage media include computer system RAM, ROM, EPROM, EEPROM, and magnetic or optical disks or tapes. It is therefore to be understood that any electronic device capable of executing the above-described functions may perform those functions enumerated above.

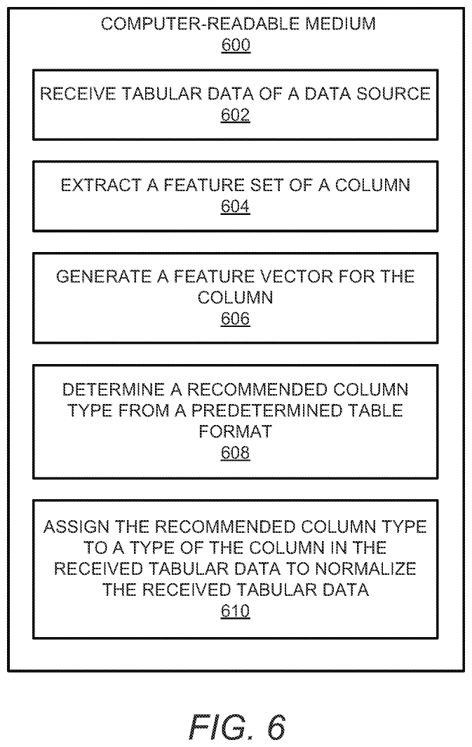

Turning now to FIG. 6, there is shown a block diagram of a computer-readable medium 600 that may have stored thereon computer-readable instructions to extract a feature set of a column of a table, generate a feature vector for the column based on the extracted feature set, and determine a recommended column type from a predefined table format through application of modeling using the feature vector, in accordance with an embodiment of the present disclosure. It should be understood that the computer-readable medium 600 depicted in FIG. 6 may include additional instructions and that some of the instructions described herein may be removed and/or modified without departing from the scope of the computer-readable medium 600 disclosed herein. The description of the computer-readable medium 600 is made with reference to the features depicted in FIGS. 1, 2, 3, and 4A to 40 for purposes of illustration. The computer-readable medium 600 may be a non-transitory computer-readable medium. The term “non-transitory” does not encompass transitory propagating signals.

The computer-readable medium 600 may have stored thereon machine-readable instructions 602-610 that a processor disposed in an apparatus 100 may execute. The computer-readable medium 600 may be an electronic, magnetic, optical, or other physical storage device that contains or stores executable instructions. The computer-readable medium 600 may be, for example, Random Access memory (RAM), an Electrically Erasable Programmable Read-Only Memory (EEPROM), a storage device, an optical disc, and the like.

The processor may fetch, decode, and execute the instructions 602 to receive a table 208 of a data source. The received table 208 may include tabular data, which may include content of the table 208. The tabular data may also include metadata for the table 208. The data source may be one of a plurality of data sources 402.

The processor may fetch, decode, and execute the instructions 604 to extract a feature set 224 of a column 210 based on the received tabular data. The feature set 224 may include a plurality of features of the column 210. The plurality of features of the columns may correlate to characteristics of the column 210.

The processor may fetch, decode, and execute the instructions 606 to generate, based on the extracted feature set 224, a feature vector 226 for the column 210. The feature vector 226 may represent characteristics of the column 210, such as the characteristic 214, based on the extracted feature set 224.

The processor may fetch, decode, and execute the instructions 608 to determine, through application of modeling using the feature vector 226, a recommended column type 220 from a predefined table format 216. The recommended column type 220 may have at least a predetermined level of match to the characteristics of the column 210.

The processor may fetch, decode, and execute the instructions 610 to assign the recommended column type 220 to a column type 212 in the received table 208 to normalize the received table 208 to the predefined table format 216.

In some examples, the feature set 224 may include column names correlated to the column, cardinality of values of data in the column, patterns of characters in the column, column data type correlated to the column, column content correlated to the column, and/or the like.

In some examples, the processor may determine a ranking of column types 218 of the predefined table format 216 based on a respective level of match to the characteristics of the column 210. The processor may select, as the recommended column type 220, one or more than one column type 218 of the predefined table format 216 having at least the predetermined level of match to the characteristics of the column.

In some examples, the processor may output the recommended column type 220. The recommended column type 220 may include a plurality of recommended column types 220 among the column types 218 for the predefined table format 216. Based on a selection of one of the plurality of recommended column types 220, the processor may assign the selected column type as the column type 212 of the column 210 to normalize the column 210 in the received table 208.

In some examples, the processor may update a machine learning model, such as the model 222 depicted in FIG. 2, based on the selected column type. In some examples, the processor may retrain the model 222 based on the selected column type. The processor may generate subsequent recommendations for column types based on the updated model 222.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the scope of the disclosure, which is intended to be defined by the following claims and their equivalents—in which all terms are meant in their broadest reasonable sense unless otherwise indicated.

What is claimed is:

1. An apparatus comprising:
a processor: and
a memory on which is stored machine-readable instructions that when executed by the processor, cause the processor to:
receive tabular data of a data source;
extract a characteristic of a column based on the tabular data;
based on the extracted characteristic of the column, determine, through application of modeling, a recommended column type from a predefined table format, wherein the recommended column type has at least a predetermined level of match to the extracted characteristic of the column; and
assign the recommended column type as a type of the column in the received tabular data to normalize the received tabular data to the predefined table format.

2. The apparatus of claim , wherein the instructions further cause the processor to:
create a feature set based on the extracted characteristic to train a model, the feature set comprising features correlated to the extracted characteristic of the column.

3. The apparatus of claim 2, wherein the features of the feature set include a field type, a data type, a value of content in the column, a number of distinct values of data in the column, a regular expression (regex) of content in the column, or a combination thereof.

4. The apparatus of claim 2, wherein the instructions further cause the processor to:
generate a feature vector for the column based on the feature set, the feature vector representing the column based on the features of the feature set.

5. The apparatus of claim 4, wherein the features in the feature set comprise column names correlated to the column, cardinality of values of data in the column, patterns of characters in the column, column data type correlated to the column, column content correlated to the column, or a combination thereof.

6. The apparatus of claim 1, wherein the instructions further cause the processor to:
based on the extracted characteristic of the column, determine a ranking of column types of the predefined table format based on a respective level of match to the extracted characteristic of the column; and
select, as the recommended column type, one or more than one column type of the predefined table format having at least the predetermined level of match to the extracted characteristic of the column.

7. The apparatus of claim 1, wherein the instructions further cause the processor to:
output the recommended column type, the recommended column type being one among a plurality of recommended column types; and
based on a selection of one of the plurality of recommended column types, assign the selected column type as the type of the column to normalize the received tabular data.

8. The apparatus of claim 7, wherein the instructions further cause the processor to:
update a machine learning model based on the selected column type; and
generate subsequent recommendations for column types based on the updated machine learning model.

9. A method comprising:
receiving, by a processor, tabular data of a data source;
extracting, by the processor, a characteristic of a column based on the received tabular data;
determining, by the processor, a feature set based on the extracted characteristic to train a model, the model to match the extracted characteristic of the column to a column type from a predefined table format;
determining, by the processor, through application of the model, a recommended column type from the predefined table format, the recommended column type having at least a predetermined level of match to the extracted characteristic of the column; and
assigning, by the processor, the recommended column type to a type of the column in the received tabular data to normalize the received tabular data to the predefined table format.

10. The method of claim 9, wherein features of the feature set include a field type, a data type, a value of content in the column, a number of distinct values of data in the column, a regular expression (regex) of content in the column, or a combination thereof.

11. The method of claim 9, further comprising:
generating a feature vector correlated to the column based on the feature set, the feature vector representing the column based on the features of the feature set.

12. The method of claim 11, wherein the features in the feature set comprises column names correlated to the column, cardinality of values of data in the column, patterns of characters in the column, column data type correlated to the column, column content correlated to the column, or a combination thereof.

13. The method of claim 9, further comprising:
based on the extracted characteristic of the column, determining a ranking of column types of the predefined table format based on a respective level of match to the extracted characteristic of the column; and
selecting, as the recommended column type, one or more than one column type of the predefined table format having at least the predetermined level of match to the extracted characteristic of the column.

14. The method of claim 9, further comprising:
outputting the recommended column type, the recommended column type comprising a plurality of recommended column types; and
based on a selection of one of the plurality of recommended column types, assigning the selected column type as the type of the column to normalize the received tabular data,

15. The method of claim 14, further comprising:
updating the model based on the selected column type; and
generating subsequent recommendations for column types based on the updated model.

16. A computer-readable medium on which is stored computer-readable instructions that, when executed by a processor, cause the processor to:
receive tabular data of a data source;
extract a feature set of a column based on the received tabular data;
based on the extracted feature set, generate a feature vector for the column, the feature vector representing characteristics of the column based on the extracted feature set;
determine, through application of modeling using the feature vector, a recommended column type from a predefined table format, the recommended column type having at least a predetermined level of match to the characteristics of the column; and
assign the recommended column type to a type of the column in the received tabular data to normalize the received tabular data to the predefined table format,

17. The computer-readable medium of claim 16, wherein the feature set comprises column names correlated to the column, cardinality of values of data in the column, patterns of characters in the column, column data type correlated to the column, column content correlated to the column, or a combination thereof.

18. The computer-readable medium of claim 16, wherein the instructions cause the processor to:
based on the characteristics of the column, determine a ranking of column types of the predefined table format based on a respective level of match to the characteristics of the column; and
select, as the recommended column type, one or more than one column type of the predefined table format having at least the predetermined level of match to the characteristics of the column.

19. The computer-readable medium of claim 16, wherein the instructions cause the processor to:
output the recommended column type, the recommended column type comprising a plurality of recommended column types; and
based on a selection of one of the plurality of recommended column types, assign the selected column type as the type of the column to normalize the received tabular data.

20. The computer-readable medium of claim 19, wherein the instructions cause the processor to:
update a machine learning model based on the selected column type; and
generate subsequent recommendations for column types based on the updated machine learning model.
